(19) United States
(12) Patent Application Publication
(10) Pub. No.: US 2010/0156693 A1
(43) Pub. Date: Jun. 24, 2010

(54) Programmable remote control system and method thereof

(75) Inventors: Chih Feng Ho, Taipei (TW); Chi Jen Lin, Taipei (TW); Tsung Chi Huang, Taipei (TW); Yi Ming Pao, Taipei (TW)

Correspondence Address: BACON & THOMAS, PLLC, 625 SLATERS LANE, FOURTH FLOOR, ALEXANDRIA, VA, 22314-1176, US

(73) Assignee: Moxa Inc., Taipei (TW)

(21) Appl. No.: 12/318,063

(22) Filed: Dec. 22, 2008

(51) Int. Cl. H04L 17/02

(52) U.S. Cl. 341/176

(57) ABSTRACT

A programmable remote control system and the method thereof are provided to solve the problem of learning a controlling language at a huge time cost in the prior art. A control command group is remotely set and stored in the triggering end for positive and negative logic determination and control. The mechanism facilitates the provision of the control command group for actively transmitting messages.

### BACKGROUND OF THE INVENTION

1. Field of Invention

The invention relates to a remote control system and the method thereof and, in particular, to a remote control system and the method thereof that set the control command group remotely.

2. Related Art

In recent years, the development in semiconductor-related industries and network technology enable automatic controlling technology to become more mature and have wider applications. For example, operators can control equipment thousands of miles away through the Internet, without being in front of the equipment directly. This does not only achieve the goals of saving manpower and reducing costs, it further makes the equipment control very convenient. When the equipment is operating in a bad working environment, the operators are relatively safe because they do not need to work under the same bad environment. Although automatic control is convenient and safe, a triggering end is required to play the role of central control when more devices are added. The triggering end centralizes the control of all devices to reduce the inconvenience in wiring and the cost in system development.

In view of this, some vendors develop programmable logic controllers as the triggering ends to receive/transmit triggering signals for controlling external input/output (I/O) devices. Generally speaking, to control external I/O devices, the triggering end has to have some preset control commands so that the triggering end can perform controls according to the preset control commands and the state of the triggering signal. However, the setting method of the control commands is complicated and has to be done through a controlling language. Therefore, if a user is not familiar with or had no experience with the controlling language, he or she cannot directly and rapidly set the control commands. Instead, the user has to refer to the manual to learn the controlling language. Consequently, this involves a huge time cost for learning the controlling language.

In summary, the prior art suffers from the problem of a lot of time cost in learning the controlling language. It is thus imperative to provide an improved technique.

### SUMMARY OF THE INVENTION

In view of the foregoing, the invention provides a programmable remote control system and the method thereof.

Disclosed programmable remote control system is used in a network environment with monitoring devices. It includes a controlling end and a triggering end. The triggering end includes: a command module, a triggering module, a processing module, and a transmitting module. The controlling end enters and transmits a control command group that consists of determining condition, valid condition, and invalid condition. The triggering end links to the monitoring devices. Its command module receives and stores the control command group. The triggering module receives the triggering signals transmitted from the monitoring devices. The processing module executes the control command group, and selectively executes the valid condition or the invalid condition according to the determining condition and the triggering signal for generating a processing signal. The transmitting module transmits the processing signal to the corresponding monitoring device according to the control command group.

The disclosed programmable remote control method is used in a network environment with monitoring devices. It includes the steps of: entering and transmitting a control command group via a controlling end, the control command group consisting of determining condition, valid condition, and invalid condition; linking the triggering end to monitoring devices; receiving and storing the control command group by the triggering end; receiving a triggering signal transmitted from a monitoring device; executing the control command group on the triggering end and selectively executing the valid or invalid condition according to the determining condition and the triggering signal to generate a processing signal; and transmitting the processing signal to the corresponding monitoring device by the triggering end according to the control command group.

The disclosed system and method as described above differ from the prior art in that the invention sets the control command group remotely and stores the control command group in the triggering end for positive and negative logic determination and control.

Using the disclosed technique, the invention can facilitate the provision of the control command group for actively transmitting messages.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed programmable remote control system;

FIG. 2 is a block diagram of the disclosed programmable remote control method;

FIG. 3 is a schematic view of setting the control command groups according to the invention;

FIG. 4 is a schematic view of performing advanced settings on the control command groups according to the invention; and

FIG. 5 is a schematic view of the setting window in the invention.

### DETAILED DESCRIPTION OF THE INVENTION

The present invention will be apparent from the following detailed description, which proceeds with reference to the accompanying drawings, wherein the same references relate to the same elements.

Before describing the disclosed programmable remote control system and the method thereof, we first define the terms used in the specification. The control command group referred herein consists of determining condition, valid condition, and invalid condition. In practice, the control command group uses IF, THEN, and ELSE to represent determining condition, valid condition, and invalid condition, respectively. It has a single-layer command structure with positive and negative logic determinations. For example, suppose the control command group is ‘IF (DI-1 ON) THEN (Send Active Message) ELSE (Send E-mail)’. Its determining condition is ‘(DI-1 ON)’; its valid condition is ‘(Send Active Message)’; and its invalid condition is ‘(Send E-mail)’. The control command group indicates that when the determining condition ‘(DI-1 ON)’ is valid, the valid condition ‘(Send Active Message)’ is executed. Otherwise, the invalid condition ‘(Send E-mail)’ is executed. In particular, the determining condition ‘(DI-1 ON)’ means that the digital input port DI-1 detects an ON. The valid condition ‘(Send Active Message)’ is transmitting a message, e.g., actively transmitting a message packet. The invalid condition ‘(Send E-mail)’ is transmitting an E-mail message. The so-called single-layer command structure means that no other control command group is included inside the control command group. Besides, different control command groups can further be linked by command-setting an internal buffer. That is, correlations can be built for different control command groups at the controlling end, so that the triggering end can simultaneously execute several related control command groups. The internal buffer mentioned here can be the storage space of an electronic operating platform, such as flash memory, hard disk drives, etc.

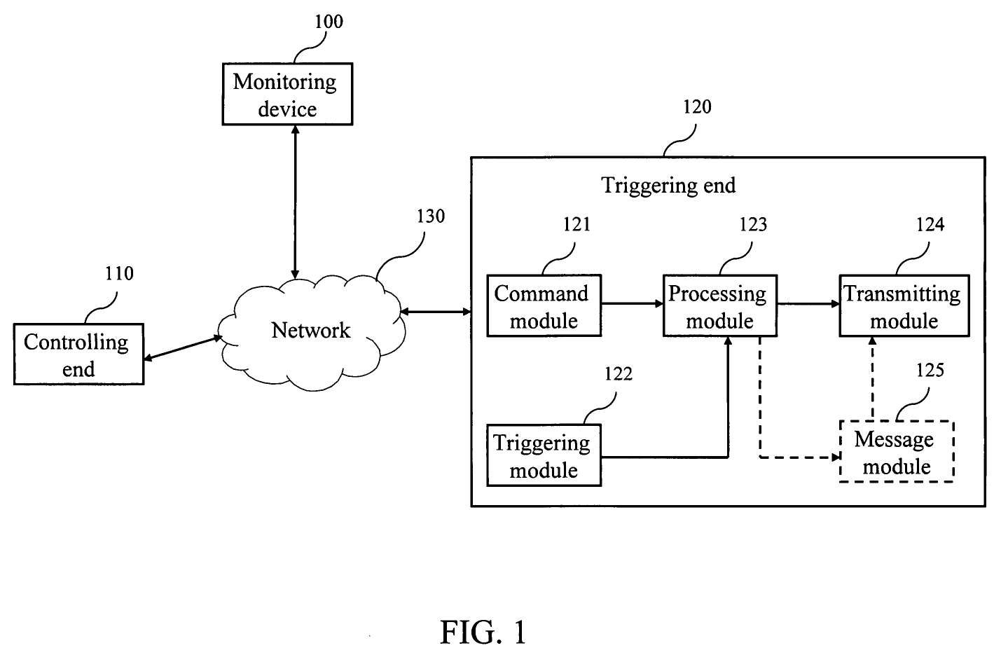

Please refer to FIG. 1, which is a block diagram of the disclosed programmable remote control system. The system includes: a monitoring device 100, a controlling end 110, a triggering end 120, and a network 130. The triggering end 120 further includes: a command module 121, a triggering module 122, a processing module 123, a transmitting module 124, and a message module 125. The monitoring device 100 is an input/output (I/O) device with the monitoring function, such as a network camera and infrared (IR) sensor. It can transmit and receive a triggering signal to and from the triggering end 120 via the network 130.

The controlling end 110 is used to enter and transmit the control command group consisting of determining condition, valid condition, and invalid condition. The control command group may further include one of the determining conditions of timing, counting, and mileage. For example, suppose the determining condition is ‘(T1 TIMEOUT)’, used to determine whether the timing T1 has run out. Moreover, the control command group can include a web site address and the path of a web program, so that a hint message can be transmitted accordingly. Since the control command group has been defined and explained before, it is not repeated here again.

The triggering end 120 links to the monitoring device 100 for transmitting and receiving the triggering signal. The command module 121 receives and stores the control command group transmitted from the controlling end 110 via the network 130. In practice, the controlling end 110 can be computing device such as the personal computer (PC) or personal digital assistant (PDA). Besides, the triggering end 120 along with a timer not shown in the drawing can be used to implement timing determination inside the processing module 123. For example, suppose the control command group is ‘IF (DI-1 ON) THEN (DO-1 ON 1 s) ELSE (DO-1 ON 8 s)’. It means that when the digital input port DI-1 is ON, its digital output port DO-1 starts for 1 second. Otherwise, the digital output port DO-1 starts for 8 seconds.

The triggering module 122 receives the triggering signal transmitted from the monitoring device 100. For example, if the monitoring device 100 is a network camera, it can be set to start videotaping when the camera image changes. A triggering signal is further sent to the triggering end 120. As a result, the triggering end 122 receives the triggering signal transmitted from the monitoring device 100 (e.g., network camera) and learns from the triggering signal that the monitoring device 100 is videotaping. In practice, the triggering module 122 can have several digital input ports, each of which is associated with a port number (e.g., DI-0, DI-1, . . . , DI-n, where n is a positive integer).

The processing module 123 executes the control command group and selectively executes the valid condition or the invalid condition according to the determining condition and the triggering signal for generating a processing signal. For example, suppose the control command group executed by the processing module 123 is ‘IF (DI-1 ON) THEN (Send Active Message) ELSE (Send E-mail)’. The determining condition ‘(DI-1 ON)’ and the triggering signal are then used to decide whether to execute the valid condition ‘(Send Active Message)’ or the invalid condition ‘(Send E-mail)’. That is, when the triggering signal representing that the digital port DI-1 changes its state to ON is received, the valid condition is executed to generate the processing signal of transmitting messages. Otherwise, the processing signal of transmitting an E-mail message is generated.

The transmitting module 124 transmits the processing signal to the corresponding monitoring device 100 according to the control command group. For example, suppose the control command group is ‘IF (DI-1 ON) THEN (DO-1 ON) ELSE (DO-1 OFF)’. The processing module 123 of the triggering end 120 produces a processing signal according to the execution result. The produced processing signal is transmitted by the transmitting module 124 via the digital output port to the corresponding monitoring device 100. In practice, the transmitting module 124 can have several digital output ports, each of which is associated with a port number (e.g., DO-0, DO-1, . . . , DO-n, where n is a positive integer).

Moreover, the triggering end 120 can further include a message module 125 to generate a hint message according to the processing signal. The hint message is transmitted by the transmitting module 124 to other output devices (not shown) for output. The hint message can be one of E-mail message, short message, and warning message for the user to quickly know the state of the monitoring device 100. For example, when the hint message is an E-mail message, it is displayed on the display device of a computer. If the hint message is a short message, it is displayed on the liquid crystal display (LCD) of a mobile phone. If the hint message is a warning message, it is output through a speaker or a light-emitting diode (LED).

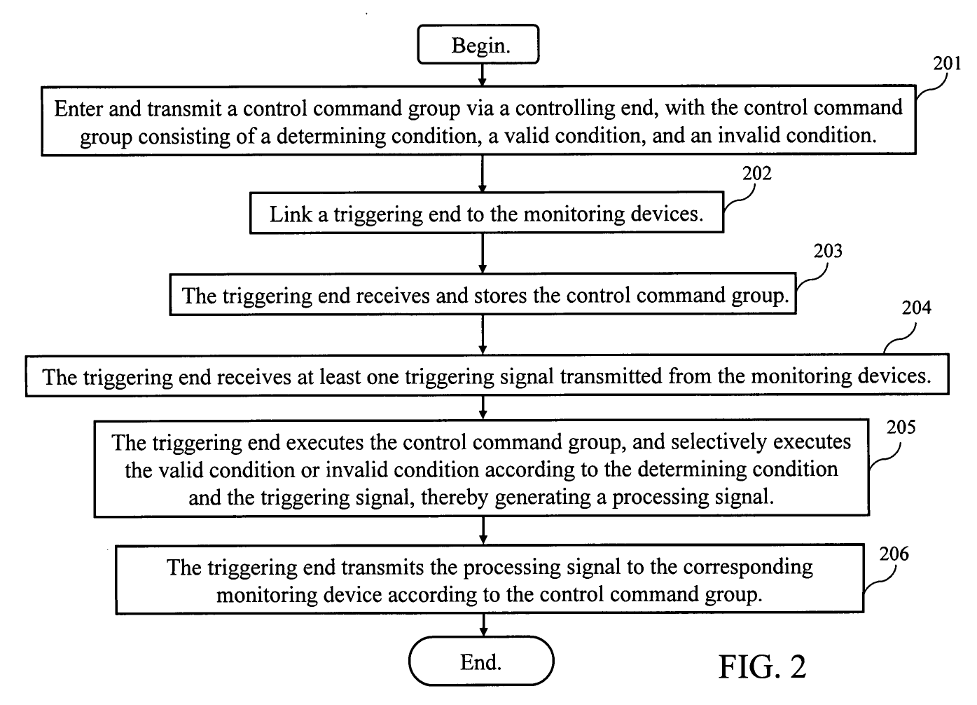

FIG. 2 is a flowchart of the disclosed programmable remote control method. The method includes the following steps. In step 201, a control command group is entered and transmitted via a controlling end 110, the control command group consisting of determining condition, valid condition, and invalid condition. In step 202, the triggering end 120 and the monitoring device 100 are linked. In step 203, the triggering end 120 receives and stores the control command group. In step 204, the triggering end 120 receives the triggering signal transmitted from the monitoring device. In step 205, the triggering end 120 executes the control command group and selectively executes the valid or invalid condition according to the determining condition and the triggering signal for generating a processing signal. In step 206, the triggering end 120 transmits the processing signal to the corresponding monitoring device 100 according to the control command group. Through the above-mentioned steps, a user can set the control command group remotely and store it at the triggering end for performing positive and negative logic determinations and control. Thus, the disclosed method facilitates the provision of the control command group and actively transmits messages. In addition, in step 205 after generating the processing signal, the method can generate a hint message according to the processing signal. The hint message is transmitted by the transmitting module 124 to the output device for output. The triggering end 120 computes the executing time.

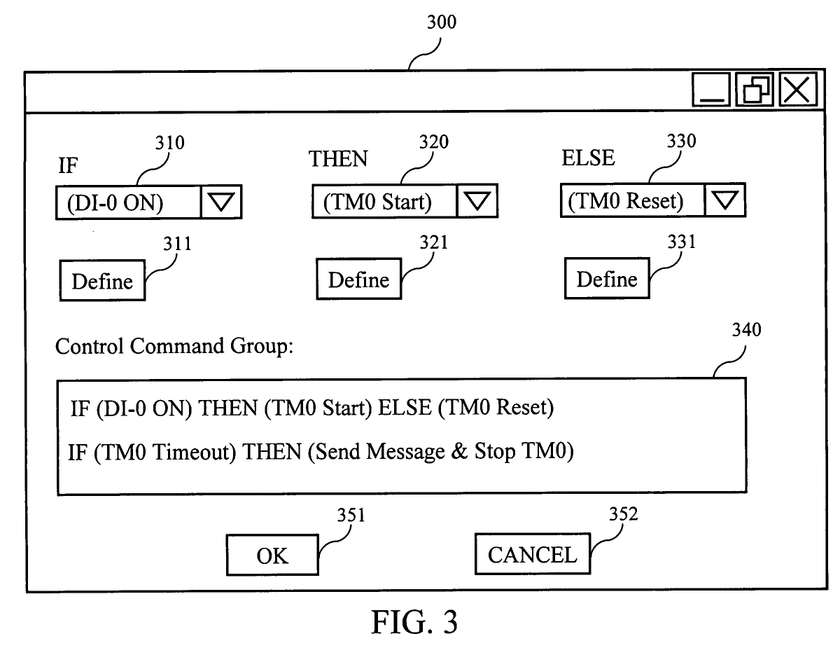

Please refer to FIGS. 3 to 5 for an embodiment of the invention. FIG. 3 is a schematic view of setting the control command group according to the invention. The drawing shows a command window 300, a determining condition entering field 310, a determining condition defining field 311, a valid condition entering field 320, a valid condition defining field 321, an invalid condition entering field 330, an invalid condition defining field 331, a control command group displaying field 340, an OK element 351, and a CANCEL element 352. The user can use the command window 300 of the controlling end 110 to set the control command group with the determining condition, the valid condition, and the invalid condition.

When the user wants to set a door lock system, he or she can enter the determining condition via the determining condition entering field 310 of the command window 300 at the controlling end 110. The entering method can be a done by selecting from a dropdown menu or clicking the determining condition defining field 311 to generate an entering window (not shown) for the user to enter the determining condition. For example, the user enters the determining condition ‘(DI-0 ON)’ using a keyboard. Afterwards, the same method is employed to enter a valid condition ‘(TM0 Start)’ and an invalid condition ‘(TM0 Reset)’ in the valid condition entering field 320 and the invalid condition entering field 330. A control command group ‘IF (DI-0 ON) THEN (TM0 Start) ELSE (TM0 Reset)’ is then generated. It should be noted that if the valid condition or invalid condition in the control command group is not provided, then it means that no action is taken when executing the valid condition or the invalid condition. However, at least one of these two conditions has to be specified.

As described above, the user can use the same method to set multiple control command groups. For example, the user newly adds another control command group ‘IF (TM0 Timeout) THEN (Send Message & Stop TM0)’. Afterwards, the defined control command group is displayed in the control command group displaying field 340 for the user to confirm. By clicking the OK element 351, the control command group is transmitted to the triggering end via the network 130. By clicking the CANCEL element 352, the setting is canceled. It should be noted that during the process of transmitting the control command group, it can be coded into an executable byte code. It is executed after the decoding of the triggering end. Since the encoding and decoding of the byte code belong to the prior art, it is not further described herein.

The triggering end 120 linked to the monitoring device 100 (e.g., a door lock system) receives and stores the control command group transmitted from the controlling end 110 via the command module 121. The triggering signal transmitted from the monitoring device 100 is received by the triggering module 122. At this moment, the processing module 123 executes the control command group stored in the command module 121, e.g., ‘IF (DI-0 ON) THEN (TM0 Start) ELSE (TM0 Reset)’ and ‘IF (TM0 Timeout) THEN (Send Message & Stop TM0)’. The valid condition or invalid condition is selectively executed according to the determining condition and the triggering signal to generate the processing signal. For the current example, suppose that the digital input port DI-0 is linked to the state signal (e.g., ON or OFF) of an automatic door. When the automatic door is ON, the monitoring device 100 transmits an ON state signal to the triggering end 120. According to the determining condition and the triggering signal received by the triggering module 122, the processing module 123 learns that the determining condition ‘(DI-0 ON)’ in the control command group ‘IF (DI-0 ON) THEN (TM0 Start) ELSE (TM0 Reset)’ is valid. Therefore, the processing module 123 executes the valid condition (i.e., ‘(TM0 Start)’). In particular, ‘TM0 ’ represents the timer number ‘0’, and ‘Start’ represents that the timer starts counting. ‘Reset’ in the invalid condition represents resetting the timer. For example, the timer first zeros the previously counted value and start recounting. Furthermore, ‘Stop’ can be used to represent zeroing the timer and stop counting.

When the timer counts over a specified time, the processing module 123 learns that the determining condition ‘(TM0 Timeout)’ of the other control command group ‘IF (TM0 Timeout) THEN (Send Message & Stop TM0)’ is valid. This is because the timer number ‘0’ is timeout, satisfying the determining condition. In this case, the processing module 123 selectively executes the valid condition ‘(Send Message & Stop TM0)’ to generate the processing signal of close the door. In particular, ‘Send Message’ represents sending a message. ‘&’ represents the Boolean operator ‘AND’ and can be directly replaced by ‘AND’. ‘Stop’ and ‘TM0’ have been described before and are not repeated here. The transmitting module 124 transmits the signal of closing the door and a predetermined message (e.g., the text ‘Close automatic door’) to the corresponding monitoring device 100. The timer number ‘0’ stops counting. The predetermined message can be used by the message module 125 to generate a corresponding hint message. In addition, the hint message can be transmitted via the network 130 to a dynamic web site (e.g., the web site with CGI, PHP, or ASP web programs). The transmission method will be detailed later.

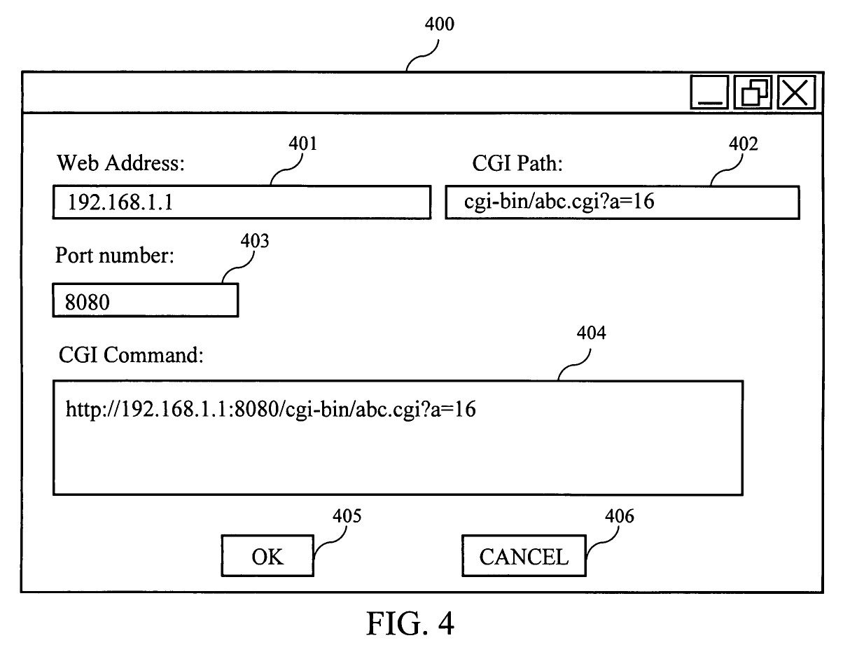

FIG. 4 is a schematic view of performing advanced settings of the control command group according to the invention. As described before, the hit message can be transmitted via the network 130 to a dynamic web site according to the web address and the path of the web program recorded in the control command group. For example, when the valid condition is ‘Send CGI command’, it means that the hint message is to be transmitted to the dynamic web site. Advanced parameter settings can be performed in an advanced command window 400. For example, the user can use a web address entering field 401, a path entering field 402, and a port number entering field 403 to assign a web site and the path of the web program and the port number. For example, one enters the web address ‘192.168.1.1’ in the web address entering field 401, the path ‘cgi-bin/abc.cgi?a=16’ of the web program ‘abc.cig’ in the path entering field 402. In particular, ‘cgi-bin’ is a directory name, ‘a’ is a parameter name, ‘16’ is a parameter value, and the port number is ‘80’ or ‘8080’. They are further displayed in the command displaying field 404 for the user to confirm. After the confirmation, the user can click the OK element 405 to save the settings or the CANCEL element 406 to cancel them. Therefore, the hint message can be transmitted to the designated web site for the web program stored in the specified path to process.

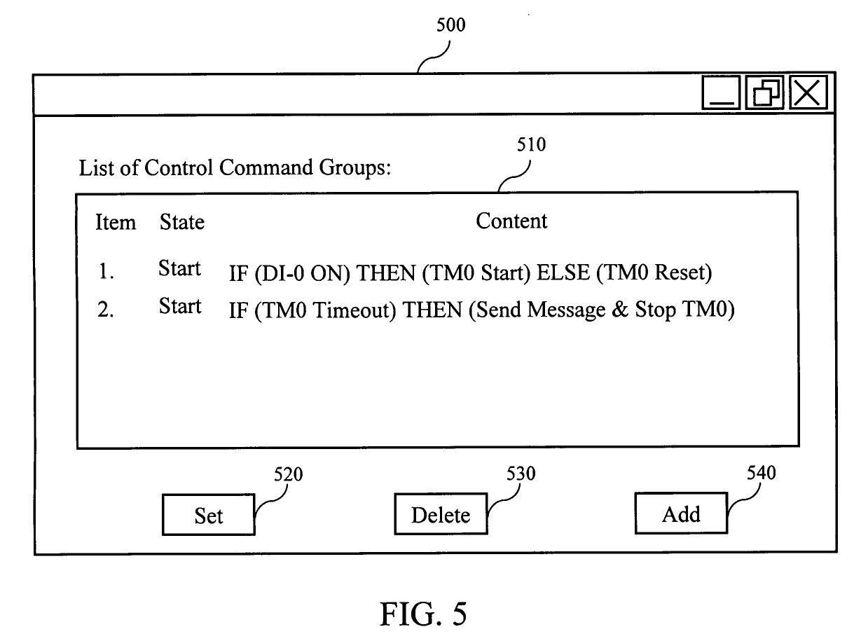

Finally, FIG. 5 is a schematic view of the setting window according to the invention. As mentioned before, there can be several the control command groups. In practice, when the user wants to set a control command group, he or she can use the control command group displaying field 510 in the setting widow 500 to display all the current control command groups (e.g., ‘IF (DI-0 ON) THEN (TM0 Start) ELSE (TM0 Reset)’ and ‘IF (TM0 Timeout) THEN (Send Message & Stop TM0)’). The user then selects the control command group to be set. He/she clicks the setting element 520 to set the selected control command group. The setting method is the same as that described before via the command window 300. Therefore, it is not repeated here again. Besides, the user can click a deleting element 530 to delete the selected control command group, or click an adding element 540 to add another control command group. It should be particularly noted that the above-mentioned elements are mentioned for the convenience of explanation. The invention does not restrict the type and method of setting elements.

In summary, the invention differs from the prior art insetting control command groups remotely and storing them in the triggering end for positive and negative logic determinations and control, achieving active responses. Using this technique, the invention can effectively save the time cost of learning a controlling language. The user can preset the response results. This solves existing problems in the prior art. Therefore, the invention facilitates the provision of the control command groups and actively transmits messages.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A programmable remote control system used in a network environment with at least monitoring device, the system comprising:
a controlling end, which is used to enter and transmit a control command group consisting of a determining condition, a valid condition, and an invalid condition; and
a triggering end, which links to the monitoring devices and includes:
a command module, which receives and stores the control command group;
a triggering module, which receives at least one triggering signal transmitted from the monitoring devices;
a processing module, which executes the control command group and selectively executes the valid condition or the invalid condition according to the determining condition and the triggering signals, thereby generating a processing signal; and
a transmitting module, which transmits the processing signal to the corresponding monitoring device according to the control command group.

2. The programmable remote control system of claim 1, wherein the control command group is a single-layer command structure with positive and negative logic determinations.

3. The programmable remote control system of claim 1, wherein the control command group includes a web address and the path of a web program.

4. The programmable remote control system of claim 1, wherein the control command group includes one determining condition selected from the group consisting of timing determination, counting determination, and mileage determination.

5. The programmable remote control system of claim 1, wherein the triggering end further includes a message module for generating a hint message according to the processing signal and sends the hint message via the transmitting module to an output device for output.

6. The programmable remote control system of claim 5, wherein the hint message is an E-mail message, a mobile phone short message, or a warning message.

7. The programmable remote control system of claim 1, wherein the triggering end has a timer for timing an execution time.

8. The programmable remote control system of claim 1, wherein the controlling end further encodes the control command group into a byte code.

9. A programmable remote control method used in a network environment with at least one monitoring devices, the method comprising the steps of:
entering and transmitting via a controlling end a control command group consisting of determining condition, valid condition, and invalid condition;
linking a triggering end to the monitoring devices;
receiving and storing the control command group by the triggering end;
receiving at least one triggering signal transmitted from the monitoring devices;
executing the control command group on the triggering end and selectively executing the valid or invalid condition according to the determining condition and the triggering signal to generate a processing signal; and
transmitting the processing signal to the corresponding monitoring device by the triggering end according to the control command group.

10. The programmable remote control method of claim 9, wherein the control command group is a single-layer command structure with positive and negative logic determinations.

11. The programmable remote control method of claim 9, wherein the control command group includes a web address and the path of a web program.

12. The programmable remote control method of claim 9, wherein the control command group includes one determining condition selected from the group consisting of timing determination, counting determination, and mileage determination.

13. The programmable remote control method of claim 9, wherein the triggering end further includes generating a hint message according to the processing signal and sends the hint message via a transmitting module to an output device for output.

14. The programmable remote control method of claim 13, wherein the hint message is an E-mail message, a mobile phone short message, or a warning message.

15. The programmable remote control method of claim 9, wherein the triggering end is further used for timing an execution time.

16. The programmable remote control method of claim 9, wherein the controlling end further encodes the control command group into a byte code.
